(19) United States
(12) Patent Application Publication
(10) Pub. No.: US 2024/0181857 A1
(43) Pub. Date: Jun. 6, 2024

(54) WINDSHIELD PROTECTION APPARATUS

(71) Applicant: Keith Thomas Black, Edmonton (CA)

(72) Inventor: Keith Thomas Black, Edmonton (CA)

(21) Appl. No.: 18/062,170

(22) Filed: Dec. 6, 2022

(51) Int. Cl. B60J 11/08; B60J 1/20

(52) U.S. Cl. CPC B60J 11/08; B60J 1/2094

(57) ABSTRACT

A windshield protection apparatus configured to be releasably superposed to an exterior surface of a windshield on a vehicle so as to inhibit damage to the windshield of the vehicle. The present invention includes a body wherein the body is mateably shaped to the windshield of the vehicle for which it will be superposed. The body includes a first layer, second layer and a third layer wherein the third layer is adjacent to the exterior surface of the windshield. The first layer is manufactured from rubber or other similar material and the second layer is manufactured from Kevlar® or other similar material. The third layer is manufactured from a vinyl, rubber or similar material. The body includes embedded therein a first magnet set having a plurality of magnets located proximate the perimeter edge of the body. A metal disk set is releasably secured to the interior surface of the windshield.

### FIELD OF THE INVENTION

The present invention relates generally to motor vehicle accessories, more specifically but not by way of limitation, a windshield protection apparatus that is configured to be releasably superposed a windshield so as to inhibit damage thereto during towing of the motor vehicle.

### BACKGROUND

As is known in the art, many types of vehicles are equipped with windshields. While conventional automobiles and trucks are all equipped with windshield other vehicle types such as but not limited to off-road vehicles are also equipped with windshields. Off-road vehicles have grown in popularity over the last decade with utility terrain vehicles (UTV) becoming increasingly utilized in many parts of North America. These vehicles are used both for recreation and work and are capable of traversing difficult terrains. Utility terrain vehicles however are not street legal in most areas and are typically towed with a tow vehicle on a trailer to the area in which the utility terrain vehicle will be utilized.

While some utility terrain vehicles do not have windshields, there are many models that are equipped with a windshield or the owner has installed a windshield thereon. These windshields are built for high impact situations and as such the windshields can cost thousands of dollars. One of the problems that owners can encounter when towing utility terrain vehicles is the debris that can be dislodged while towing. Most often the UTV's are towed in areas and on roads that will have loose rocks and similar objects. These rocks can be propelled by the tires of the tow vehicle, as well as on-coming traffic, towards the UTV being towed thereby and can often cause damage to the UTV and the windshield as well. An exposed windshield of a UTV being towed can be damaged resulting in thousands of dollars in repairs.

Accordingly, it is intended within the scope of the present invention to provide a protection apparatus for a windshield of a utility terrain vehicle wherein the present invention is releasably superposed the windshield of a utility terrain vehicle.

### SUMMARY OF THE INVENTION

It is the object of the present invention to provide a windshield protection apparatus that is configured to be releasably superposed a windshield of a vehicle wherein the present invention includes a body wherein the body is mateably shaped to the windshield of the motor vehicle.

Another object of the present invention is to provide a protection device for windshields to inhibit damage thereto while the vehicle is being towed wherein the body of the present invention includes a first layer, second layer and third layer.

A further object of the present invention is to provide a windshield protection apparatus that is configured to be releasably superposed a windshield of a vehicle wherein the third layer is adjacent the exterior surface of the windshield of the vehicle and is manufactured from rubber or similar material.

Still another object of the present invention is to provide a protection device for windshields to inhibit damage thereto while the vehicle is being towed wherein the second layer of the body is intermediate the first layer and third layer.

An additional object of the present invention is to provide a windshield protection apparatus that is configured to be releasably superposed a windshield of a vehicle wherein the second layer is manufactured from Kevlar® or other similar material.

Yet a further object of the present invention is to provide a protection device for windshields to inhibit damage thereto while the vehicle is being towed wherein the first layer of the body is manufactured from flexible rubber, vinyl or similar material.

Another object of the present invention is to provide a windshield protection apparatus that is configured to be releasably superposed a windshield of a vehicle wherein the present invention includes a first set and a set of metal disks.

Still a further object of the present invention is to provide a protection device for windshields to inhibit damage thereto while the vehicle is being towed wherein the first set of magnets are embedded into the body of the present invention.

Yet another object of the present invention is to provide a windshield protection apparatus that is configured to be releasably superposed a windshield of a vehicle wherein the metal disks are releasably secured to the inner surface of the windshield on the vehicle.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front perspective view of a windshield of an exemplary tow vehicle and the second set of magnets; and

FIG. 2 is a front perspective view of the body of the present invention; and

FIG. 3 is a cross-sectional diagrammatic view of the body of the present invention.

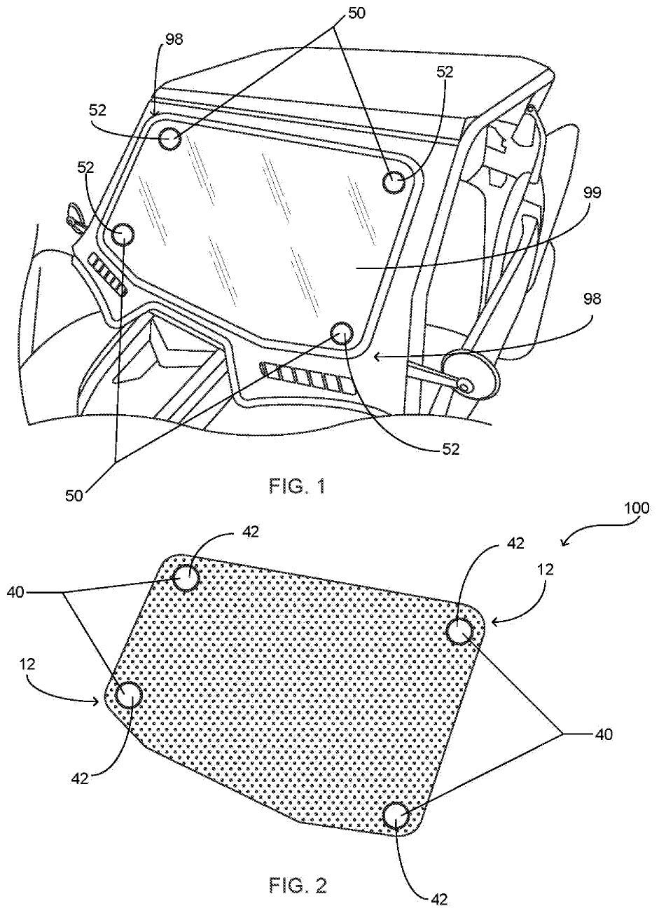

### DETAILED DESCRIPTION

Referring now to the drawings submitted herewith, wherein various elements depicted therein are not necessarily drawn to scale and wherein through the views and figures like elements are referenced with identical reference numerals, there is illustrated a windshield protection apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures herein, the windshield protection apparatus 100 includes a body 10. The body 10 includes a first layer 15, second layer 20 and third layer 30 that are further discussed herein. The body 10 of the windshield protection apparatus 100 is flat in form and has a peripheral shape that is created so as to mateably superposed a windshield 99 to which the windshield protection apparatus 100 is releasably superposed. While a UTV is discussed herein as being a vehicle to which the windshield protection apparatus 100 is releasably superposed to a windshield 99 thereof, it should be understood within the scope of the present invention that the windshield protection apparatus 100 could be shaped so as to be releasably superposed to alternate types of vehicles. By way of example but not limitation, the windshield protection apparatus 100 could be formed to be releasably superposed to a conventional automobile windshield.

The windshield protection apparatus 100 includes a first magnet set 40 and a metal disks 50. The first magnet set 40 is embedded into the body 10 utilizing suitable techniques. The first magnet set 40 includes four magnets 42 wherein the four magnets 42 are located proximate the corners 12 of the body 10. The metal disks 50 is releasably secured to the interior surface of the windshield 99 utilizing suitable techniques such as but not limited to chemical adhesion. The metal disks 50 comprises four magnets 52 that are secured to the windshield 99 proximate the corners 98 thereof. It should be understood within the scope of the present invention that the first magnet set 40 and metal disks 50 could be comprised of alternate quantities of magnets 42, 52 wherein the first magnet set 40 and metal disks 50 could have fewer or more than four magnets 42,52. Furthermore, it is contemplated within the scope of the present invention that the magnets 42, 52 could be placed in alternate locations in addition to the locations illustrated herein. It should be understood within the scope of the present invention that the magnets 42, 52 are placed so as to be in axial alignment upon the windshield protection apparatus 100 being superposed the exterior surface of the windshield 99.

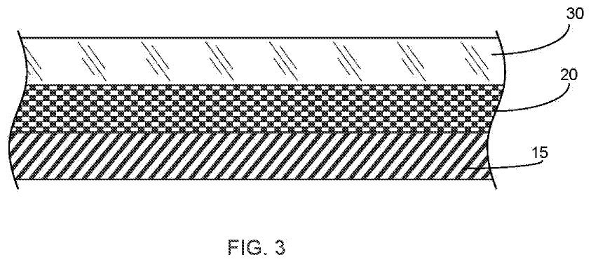

The body 10 of the windshield protection apparatus 100 includes the first layer 15, second layer 20 and third layer 30 which are illustrated herein in FIG. 3. The first layer 15 is adjacent the exterior surface of the windshield 99 upon the body 10 being superposed the exterior surface of the windshield 99. The first layer 15 is manufactured from a material that is configured to inhibit damage such as but not limited to scratching of the exterior surface of the windshield 99. By way of example but not limitation, it is contemplated within the scope of the present invention that the first layer 15 could be manufactured from rubber or other similar material. The second layer 20 of the body 10 is intermediate the first layer 15 and third layer 30. The second layer 20 functions to provide protection against projectiles such as but not limited to rocks and other debris. The second layer 20 is bonded to the first layer 15 utilizing suitable durable techniques. It is contemplated within the scope of the present invention that the second layer 20 is manufactured from a material such as but not limited to Kevlar®.

The body 10 includes a third layer 30 wherein the third layer 30 is bonded to the second layer 20 opposite the first layer 15 utilizing suitable techniques. The third layer 30 is manufactured from a flexible material such as but not limited to vinyl, rubber or similar material. It should be understood within the scope of the present invention that the third layer 30 could be provided in alternate thicknesses wherein a preferred embodiment of the present invention employs a thickness for the first layer 15 of at least one-quarter of an inch. While the body 10 has been illustrated and discussed herein as having a first layer 15, second layer 20 and third layer 30, it is contemplated within the scope of the present invention that the body 10 could be provided with only the first layer 15 and third layer 30 wherein the second layer 20 is not present.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A windshield protection apparatus that is configured to be releasably superposed a windshield of a vehicle wherein the windshield protection apparatus comprises:
a body, said body being mateably shaped with the windshield of the vehicle, said body having a first layer and a second layer, said body having a first magnet set embedded therein;
a metal disk set, said metal disk set releasably secured to an interior surface of the windshield; and
wherein said body is superposed an exterior surface of the windshield being releasably secured thereto with said first magnet set and said metal disk set.

2. The windshield protection apparatus releasably superposed the windshield of the vehicle as recited in claim 1, wherein said first magnet set comprises at least one magnet.

3. The windshield protection apparatus releasably superposed the windshield of the vehicle as recited in claim 2, wherein said metal disk set comprises at least one metal disk, said at least one metal disk of said metal disk set being axially aligned with said at least one magnet of said first magnet set when said body is superposed the windshield.

4. The windshield protection apparatus releasably superposed the windshield of the vehicle as recited in claim 3, wherein said first layer of said body is adjacent the exterior surface of the windshield ensuing said body being superposed the windshield.

5. The windshield protection apparatus releasably superposed the windshield of the vehicle as recited in claim 4, wherein said first layer of said body is manufactured from rubber or similar material.

6. The windshield protection apparatus releasably superposed the windshield of the vehicle as recited in claim 5, wherein said second layer of said body is manufactured from vinyl, rubber or similar material.

7. A windshield protection apparatus that is configured to be releasably superposed a windshield of a vehicle wherein the windshield protection apparatus comprises:
a body, said body being mateably shaped with the windshield of the vehicle, said body having a first layer, a second layer and a third layer, said second layer being intermediate said first layer and said third layer, said body having a plurality of magnets embedded therein, said plurality of magnets being proximate corner areas of said body;
a metal disk set, said metal disk set being comprised of a plurality of metal disks, said plurality of metal disks of said metal disk set being secured to an interior surface of said windshield; and
wherein said plurality of magnets embedded within said body and said plurality of said metal disks of said metal disk set are axially aligned subsequent said body being superposed the windshield.

8. The windshield protection apparatus releasably superposed the windshield of the vehicle as recited in claim 7, wherein said first layer of said body is manufactured from rubber.

9. The windshield protection apparatus releasably superposed the windshield of the vehicle as recited in claim 8, wherein said second layer of said body is manufactured from Kevlar® or similar material.

10. The windshield protection apparatus releasably superposed the windshield of the vehicle as recited in claim 9, wherein said third layer of said body is manufactured from a vinyl, rubber or similar material.
